(19) United States
(12) Patent Application Publication
(10) Pub. No.: US 2006/0109771 A1
(43) Pub. Date: May 25, 2006

(54) Optical pickup device

(75) Inventors: Yuichi Atarashi, Tokyo (JP); Mika Wachi, Tokyo (JP); Junji Hashimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/273,087

(22) Filed: Nov. 15, 2005

(30) Foreign Application Priority Data
Nov. 19, 2004 (JP) 2004-335856

(51) Int. Cl. G11B 7/00

(52) U.S. Cl. 369/112.01

(57) ABSTRACT

An optical pickup device, including: first, second and third light sources performing recording and/or reproduction of information for information recording surfaces of first, second and third optical information recording medium each having a protective substrate with a thickness t1, t2 and t3, respectively; a first objective optical system for guiding at least the first beam to the information recording surface of first optical information recording medium; second objective optical system provided separately from the first objective optical system, for guiding at least the third beam to information recording surface of the third optical information recording medium; and at least one light receiving element for detecting light reflected on the information recording surfaces of the first to third optical information recording media.

### TECHNICAL FIELD

The present invention relates to an optical pickup device capable of performing recording and/or reproduction of information in a compatible manner for different kinds of optical information recording media (also called optical disks).

### TECHNICAL BACKGROUND

In recent years, in optical pickup devices, laser sources used as light sources for reproducing information recorded on optical disks or recording information on optical disks have increasingly shorter wavelength. For example, laser sources with wavelengths of 400 to 420 nm, such as a blue-violet semiconductor laser and a blue SHG laser in which wavelength of an infrared semiconductor laser is converted using a second harmonic, have been put into practical use. Using these blue-violet laser sources, it is possible to, in the case of using an objective lens with a numerical aperture (NA) same as that of DVDs (digital versatile disks), record 15 to 20 GB of information on an optical disk with a diameter of 12 cm. In the case where the objective lens has an NA increased to 0.85, it is possible to record 23 to 25 GB of information on the optical disk with a diameter of 12 cm. Hereinafter, in this specification, optical disks and magneto optical disks using the blue-violet laser sources are collectively referred to as “high density optical disks”.

The high density optical disks using the objective lenses with a NA of 0.85 have larger coma caused by skew of the optical disks. Some of the high density optical disks are therefore designed to have protective layers thinner than DVDs (the thickness of the high density optical disks is 0.1 mm while the thickness of DVDs is 0.6 mm) to reduce the coma due to skew. By the way, the capability of only properly performing recording and/or reproduction of information for such a type of high density optical disks is not enough for a product value of optical disk players/recorders. In light of a fact that DVDs and CDs (compact disks) with a wide variety of information recorded are being sold at present, not only the capability of performing recording and/or reproduction of information for the high density optical disks but also a capability of properly performing recording and/or reproduction of information for, for example, DVDs and CDs owned by a user increases the commercial value of optical disk player/recorders for the high density optical disks. From such a background, the optical pickup device mounted on an optical disk player/recorder for the high density optical disk is desired to have a capability of properly performing recording and/or reproduction of information while maintaining the compatibility with both DVDs and CDs.

As a method of properly performing recording and/or reproduction of information for the high density optical disks, DVDs, and CDs while maintaining the compatibility, a method can be considered which prepares three optical systems for the high density optical disks, DVDs, and CDs and selectively switches among these optical systems according to recording density of an optical disk to be subjected to recording and/or reproduction of information. However, this method requires three types of optical systems, which is disadvantageous for miniaturization and increases costs.

In order to simplify the configuration of the optical pickup device and achieve lower costs, it is therefore preferable that, even in the optical pickup device with the compatibility, the optical systems for the high density optical disks, DVDs, and CDs are replaced with a common optical system to reduce the number of optical parts constituting the optical pickup device as much as possible. It is the most advantageous for simplification of the configuration of the optical pickup device and cost reduction to use a common objective optical system disposed to face the optical disks. In order to obtain an objective optical system common to various types of optical disks having recording/reproducing wavelength different from each other, it is necessary to form a phase structure having a wavelength dependency of spherical aberration in the objective optical system.

The European Patent No. 1304689 describes an objective optical system which has a diffraction structure as the phase structure and can be shared by the high density optical disks and conventional DVDs and CDs and an optical pickup device with this objective optical system mounted thereon.

In the optical pickup device by the conventional technology which performs recording and/or reproduction of information in a compatible manner for three different types of optical disks as described in the above patent literature, aberration correction is carried out using structures giving an optical path difference (a diffraction structure, a structure giving a phase difference, and a wavelength selective diffraction structure). In performing recording and/or reproduction of information in a compatible manner for disks of three or more standards, however, the light use efficiency becomes low, that is, the spot light intensity becomes low recording and/or reproduction of disks of any one of the standards.

One of the reasons for why the spherical aberration due to the difference in thickness between the protective substrates of the high density optical disks and CDs cannot be corrected by the diffraction structure is a tradeoff between spherical aberration correction effects of diffracted light generated by the diffraction structure on the blue-violet laser beam and infrared laser beam and the diffraction efficiencies of the blue-violet and infrared laser beams. This is because the wavelength of the blue-violet laser source used for the high density optical disks is an integral multiple (substantially double) of the wavelength of the infrared laser source used for CDs.

Specifically, when both the blue-violet laser beam and infrared laser beam are ensured to have the diffraction efficiencies, the diffraction angle of the diffracted light of the blue-violet laser beam substantially equals to that of the infrared laser beam, and the spherical aberration due to the difference in thickness between the protective substrates of the high density optical disks and CDs cannot be corrected by the diffraction structure.

On the other hand, when the diffracted light of the blue-violet laser beam and the diffracted light of the infrared laser beam are configured to have different diffraction angles, the diffraction efficiencies of the blue-violet laser beam and infrared laser beam are both lowered. In addition, the diffraction efficiency of the blue-violet laser beam can be designed to be high while the diffraction angles of the blue-violet laser beam and infrared laser beam are made different from each other. In this case, the diffraction efficiency of the infrared laser beam is very low, and the light intensity in recording and/or reproduction of CDs is insufficient.

In a technology using a phase correcting structure (a structure giving an optical path difference) formed on a surface of the optical element, as well as in the technology using the diffraction structure, the spherical aberration correction effects of the structure giving an optical path difference, similar to the diffraction structure, on the blue-violet and infrared laser beams and the transmittance of the structure giving an optical path difference have a trade-off relationship.

For the aforementioned problems, an optical pickup device is being proposed, which, in recording and/or reproduction for recording media of three or more different specifications, can perform recording and/or reproduction of information in a compatible manner for the three different types of optical disks using an objective optical element of a singlet lens. In the optical pickup device, magnifications of the beams incident to the objective optical element are designed to be different, and the diffraction structure is also incorporated.

For example, when the high density optical disks and DVDs are used, an infinite collimated beam is made incident to the objective optical element, and when CDs are used, a finite diverging beam is made incident to the objective optical element. This enables correction of the spherical aberration due to the differences in substrate thickness and wavelength between the high density optical disks and CDS, which cannot be corrected by the diffraction structure. The spherical aberration due to the difference in wavelength between the high density optical disks and DVDs is corrected by the diffraction structure provided for the objective optical element. However, when the aforementioned finite diverging beam is incident to the objective optical element, image height is generated at tracking. As a result, there is some possibility that coma is caused.

The aberration correction by the combination of the diffraction structure and setting of finite magnification of the incident beam has a problem of a trade off between the tracking property and the diffraction efficiency for at least one of the standards.

### SUMMARY OF THE INVENTION

The present invention was made in the light of the aforementioned problems, and an object of the invention is to provide an optical pickup device which is capable of properly performing recording and/or reproduction of information at high efficiency for three different kinds of disks with different recording densities, including high density optical disks using a blue-violet laser source, DVDs, and CDs, while suppressing the occurrence of coma at tracking and maintaining the compact structure.

The above object can be achieved by the following configuration.

An optical pickup device, comprises:

a first light source for emitting a first beam with a wavelength λ1 to perform recording and/or reproduction of information for an information recording surface of a first optical information recording medium having a protective substrate with a thickness t1;

a second light source for emitting a second beam with a wavelength λ2 (λ2>λ1) to perform recording and/or reproduction of information for an information recording surface of a second optical information recording medium having a protective substrate with a thickness t2 (t2≧t1);

a third light source for emitting a third beam with a wavelength λ3 (λ3>λ2) to perform recording and/or reproduction of information for an information recording surface of a third optical information recording medium having a protective substrate with a thickness t3 (t3≧t2);

a first objective optical system for guiding at least the first beam to the information recording surface of the first optical information recording medium;

a second objective optical system provided separately from the first objective optical system, for guiding at least the third beam to the information recording surface of the third optical information recording medium; and

at least one light receiving element for detecting light reflected on the information recording surfaces of the first to third optical information recording media,

wherein the second beam is guided through one of the first and second objective optical systems to the information recording surface of the second optical information recording medium,

at least one of the first and second beams is incident to the first objective optical system or the second objective optical system in an infinite collimated beam state and divergence degree of the first beam is not larger than divergence degree of the second beam.

According to the above optical pickup device, the first objective optical system is dedicated to the first beam or shared by the first and second beams, and the second objective optical system is dedicated to the third beam or shared by the second and third beams. This can make the design more flexible than that in the case where a single optical system is shared by three kinds of beams, thus maintaining a compact structure can be maintained. In addition, the aforementioned problem of the image height property is avoided to suppress the occurrence of coma. This makes it possible to avoid the problem of efficiency reduction and properly perform recording and/or reproduction of information. Moreover, the first and second objective optical systems can be provided side by side, and the optical pickup device does not increase in thickness in such a case.

### BRIEF DESCRIPTION OF THE DRAWINGS

FIG. 1 is a view schematically showing a configuration of a first optical pickup device PU1.

FIG. 2 is a view schematically showing a configuration of a second optical pickup device PU2.

FIG. 3 is a view schematically showing a configuration of a third optical pickup device PU3.

FIG. 4 is a view schematically showing a configuration of a fourth optical pickup device PU4.

### DETAILED DESCRIPTION OF THE INVENTION

In this specification, optical disks (also called optical information recording media) using a blue-violet semiconductor laser and a blue-violet SHG laser as a light source for recording and/or reproduction of information are collectively referred to as “high density optical disks”. The high density optical disks include optical disks (for example, BD: Blue-ray disks) based on a standard in which recording and/or reproduction of information is performed by an objective optical system with an NA of 0.85 and the thickness of the protective layer is about 0.1 mm and, optical disks (for example, HD DVD, also just called HD) based on a standard in which recording and/or reproduction of information is performed by an objective optical system with an NA of 0.65 to 0.67 and the thickness of the protective layer is about 0.6 mm. In addition to the optical disks each having such a protective layer on an information recording surface, the high density optical disks include optical disks each having a protective film with a thickness of about several millimeters to several tens of millimeters on the information recording surface and optical disks each having a protective layer or film with a thickness of 0. In this specification, the high density optical disks include magneto-optical disks using the blue-violet semiconductor laser and blue-violet SHG laser as the light source for recording and/or reproduction of information.

Furthermore, in this specification, DVD is a generic term for DVD series optical disks such as DVD-ROM, DVD-Video, DVD-Audio, DVD-RAM, DVD-R, DVD-RW, DVD+R, and RVD+RW, and CD is a generic term for CD series optical disks such as CD-ROM, CD-Audio, CD-Video, CD-R, and CD-RW. The high density optical disks have the highest recording density, and the recording densities of DVDs and CDs are lower in this order.

In this specification, the objective optical system indicates an optical system including an optical element (objective optical element) which has a light gathering effect and is placed closest to an optical information recording medium side so as to face the optical information recording medium in a state where the optical information recording medium is loaded on the optical pickup device. Together with the objective optical element, the objective optical system includes an optical element which can be moved by an actuator at least in an optical axis direction.

A first preferable aspect in the configuration of the present invention is that the second beam is guided to the information recording surface of the second optical information recording medium through the first objective optical system.

To be described with an example, it is assumed that one of the optical systems (first objective optical system) is shared by HDs and DVDs, and the other optical system (second objective optical system) is dedicated to CDs. In this case, it is most preferable that for the both standards, the infinite collimated beams are incident on the first objective optical system. However, from the viewpoint of the configuration of the optical pickup device and lens design, it is possible to set at least one of beams for HDs and DVDs to the infinite collimated beam. In this case, the beam incident on the objective optical element when the HD is used has lower divergence degree than that when the DVD is used, thus avoiding the problems of the image height property and the like. Furthermore, the second objective optical system can be a publicly known and widely used optical system for CDs exclusive use, so that cost can be kept low.

In the first aspect, therefore, one of more preferable modes is that each of the first and second beams is incident to the first objective optical system in the infinite collimated beam state.

Another one of the more preferable modes of the first aspect is that the first beam is incident to the first objective optical system in the infinite collimated beam state, and the second beam is incident to the first objective optical system in a finite diverging beam state.

Still another one of the more preferable modes of the first aspect is that the first beam is incident to the first objective optical system in a finite converging beam state, and the second beam is incident to the first objective optical system in the infinite collimated beam state.

In the first aspect, preferably, the first objective optical system comprises an aberration correcting structure which corrects spherical aberration due to a difference in wavelength between the first and second beams and/or chromatic aberration of the first beam.

More preferably, the aberration correcting structure is an optical path difference giving structure. The “optical path difference giving structure” represents a structure giving an optical path difference according to the wavelength of the beams passing therethrough and includes a phase difference giving structure, a diffraction structure, and a wavelength selective diffraction structure.

Still more preferably, the aberration correcting structure is divided into a plurality of regions and includes different functions for respective regions. Such functions include a diffraction limiting function.

In the first aspect, preferably, the second objective optical system comprises an aspheric surface which has a wavefront aberration of not less than 0.07λ3 rms when a focused spot is formed on the information recording surface of the third optical information recording medium.

In a preferable mode, the optical pickup device of the first aspect further comprises an objective optical system drive unit for holding the first and second objective optical systems and for switching between the first and second objective optical systems depending on one of the optical information recording media subjected to reproduction and/or recording of information.

The first and second objective optical systems can be configured to be mechanically switched each other according to the kind of the recording medium subjected to reproduction and/or recording, that is, configured into a so-called twin lens system (also called a two lens system or 2 lens system). As for the mechanical switching of the first and second objective optical elements, some methods achieving an enough mechanical precision have been already known and can be preferably used. With such a configuration, some of the optical elements constituting the optical pickup device can be shared by the first and second objective optical systems, and a recording medium drive unit to rotatably drive recording media can be shared, thus achieving a simple structure.

In a preferable mode, the optical pickup device of the first mode further comprises: a first recording medium drive unit for holding and rotatably driving the first and second optical information recording media when recording and/or reproduction of information is performed for the first and second information recording media; and a second recording medium drive unit for holding and rotatably driving the third optical information recording medium when recording and/or reproduction of information is performed for the third optical information recording medium.

Such a mode can eliminate the need to mechanically switch between the first and second objective optical systems, thus simplifying the optical systems.

Moreover, in a preferable mode, the optical pickup device of the first aspect comprises: a first optical system comprising the first and second light sources, the first objective optical system, and a first photodetector; and a second optical system comprising the third light source, the second objective optical system, and a second photodetector, the first and second optical systems being independently provided, wherein the first optical system is used when reproduction and/or recording is performed for the first and second optical recording media, and the second optical system is used when reproduction and/or recording is performed for the third optical information recording medium. With such a configuration, it is possible to obtain a pickup system performing reproduction and/or recording for three kinds of recording media with an inexpensive structure, for example, by using an optical system shared by HDs and DVDs and an optical system for CDs available at low cost.

In another preferable mode, the optical pickup device of the first aspect further comprises a beam splitter for transmitting at least one of the beams and bending an optical path of at least another one of the beams when the first to third beams pass through the beam splitter in an optical path common to the first to third beams, wherein the first and second beams having passed through the beam splitter are incident to the first objective optical system and the third beam having passed through the beam splitter is incident to the second objective optical system.

Such a mode can allow some of the optical elements of the optical pickup device to be shared and eliminate the need to mechanically switch between the objective optical systems. It is therefore possible to perform reproduction and/or recording for three kinds of recording media with a simple structure.

In the first aspect, preferably, the first and second light sources are assembled into a single unit. More preferably, the optical pickup device comprises a light receiving element shared when reproduction and/or recording of information is performed for the information recording surfaces of the first and second information recording media and a light emitter and receiver integrated source unit including the first and second light sources integrated.

In the first aspect, preferably, the optical pickup device comprises a divergence angle converting element for changing divergence degree of the beams incident to the first objective optical system. The divergence angle converting element includes a collimator and a beam expander.

In a more preferable mode, the divergence angle converting element comprises a wavelength selective optical path giving structure and varies the divergence degree between the first and second beams.

In another more preferable mode, the divergence angle converting element is movable in an optical axis direction and is disposed at different positions between a case in which the first beam is transmitted and a case in which the second beam is transmitted.

More preferably, when the divergence angle converting element is included, the light receiving element is shared when reproduction and/or recording of information is performed for the information recording surfaces of the first and second optical information recording media.

In the first aspect, one of the preferable modes is that the third beam is incident to the second objective optical system in a finite diverging beam state. The diverging beam emitted from the light source is directly incident to the objective optical system, and the optical systems can be therefore simplified.

Another preferable mode is that the third beam is incident to the second objective optical system in an infinite collimated beam state. Making the third beam incident to the objective optical system as an infinite collimated beam allows the optical system to have excellent tracking property.

In the optical pickup device of the first aspect, preferably, each of the first to third beams is incident to the first or second objective optical system in an infinite collimated beam state. Such an aspect allows the objective optical systems to have excellent tracking property.

In the optical pickup device of the first aspect, preferably, the light receiving element is shared when reproduction and/or recording of information is performed for the information recording surfaces of the first, second, and third optical information recording media.

In the configuration of the present invention, a second preferable aspect is that the second beam is guided to the information recording surface of the second optical information recording medium through the second objective optical system. An example thereof is a case where the first objective optical system is dedicated to HDs and the second objective optical system is shared by DVDs and CDs. In this case, preferably, the first objective optical system includes an optical element to correct chromatic aberration for blue wavelength. On the other hand, the second objective optical system can be preferably a publicly-known DVD/CD compatible optical system.

In the second aspect, a preferable mode is that the first beam is incident to the first objective optical system in the infinite collimated beam state and the second beam is incident to the second objective optical system in the infinite collimated beam state.

In the second aspect, another preferable mode is that the first beam is incident to the first objective optical system in the infinite collimated beam state, and the second beam is incident to the second objective optical system in a finite diverging beam state.

In the second aspect, still another preferable mode is that the first beam is incident to the first objective optical system in a finite converging beam state and the second beam is incident to the second objective optical system in the infinite collimated beam state.

In the second aspect, as described above, it is preferable that the first objective optical system comprises a first aberration correcting structure for correcting chromatic aberration of the first beam.

In the second aspect, it is preferable that the second objective optical system comprises a second aberration correcting structure which corrects spherical aberration due to a wavelength difference between the second and third beams and spherical aberration due to a thickness difference between the protective substrates of the second and third optical information recording medium.

In the second aspect, preferably, the first objective optical system comprises an aspheric surface which has wavefront aberration not less than 0.07λ1 rms when a focused spot is formed on the information recording surface of the first optical information recording medium.

In a preferable mode, the optical pickup device of the second aspect comprises an objective optical system drive unit for holding the first and second objective optical systems and switching between the first and second objective optical systems depending on one of the optical information recording media subjected to reproduction and/or recording of information.

With such a mode, it is possible to share some of the optical elements constituting the optical pickup device and share a recording medium drive unit to rotatably drive the recording media, thus achieving a simple structure.

In another preferable mode, the optical pickup device of the second aspect further comprises: a first recording medium drive unit for holding and rotatably driving the first optical information recording medium when recording and/or reproduction of information is performed for the first optical information recording medium; and a second recording medium drive unit for holding and rotatably driving the second and third optical information recording media when recording and/or reproduction of information is performed for the second and third optical information recording media.

Such a mode eliminates the need to mechanically switch between the first and second objective optical systems, thus simplifying the structures of the optical systems.

Furthermore, in a preferable mode, the optical pickup device of the second aspect comprises: a first optical system comprises the first light source, the first objective optical system, and a first photodetector; and a second optical system comprises the second and third light sources, the second objective optical system, and a second photodetector, the first and second optical system being independently provided, wherein the first optical system is used when reproduction and/or recording is performed for the first optical information recording medium, and the second optical system is used when reproduction and/or recording is performed for the second and third optical information recording media.

With such a configuration, it is possible to obtain an optical pickup device performing reproduction and/or recording for three kinds of recording media with an inexpensive, for example, by using the optical system exclusive to HDs and the compatible optical system for DVDs and CDs available at low cost.

In another preferable mode, the optical pickup device of the second aspect comprises a beam splitter for transmitting at least one of the beams and bending an optical path of at least another one of the beams when the first to third beams pass through the beam splitter in an optical path common to the first to third beams, wherein the first beam having passed through the beam splitter is incident to the first objective optical system and the second and third beams having passed through the beam splitter are incident to the second objective optical system.

Such a mode can allow some of the optical elements of the optical pickup device to be shared and eliminate the need to mechanically switch between the objective optical systems. It is therefore possible to perform reproduction and/or recording of information for three kinds of recording media with a simple structure.

In the second aspect, preferably, the second and third light sources are assembled into a single unit.

In the second aspect, a preferable mode is that the third beam is incident to the second objective optical system in a finite diverging beam state.

In the second aspect, another preferable mode is that the third beam is incident to the second objective optical system in the infinite collimated beam state.

In the second aspect, still another preferable mode is that each of the first to third beams is incident to the objective optical system in the infinite collimated beam state.

In the second aspect, preferably, the light receiving element is shared when reproduction and/or recording of information is performed for the information recording surfaces of the first, second, and third optical information recording media.

### PREFERRED EMBODIMENTS OF THE INVENTION

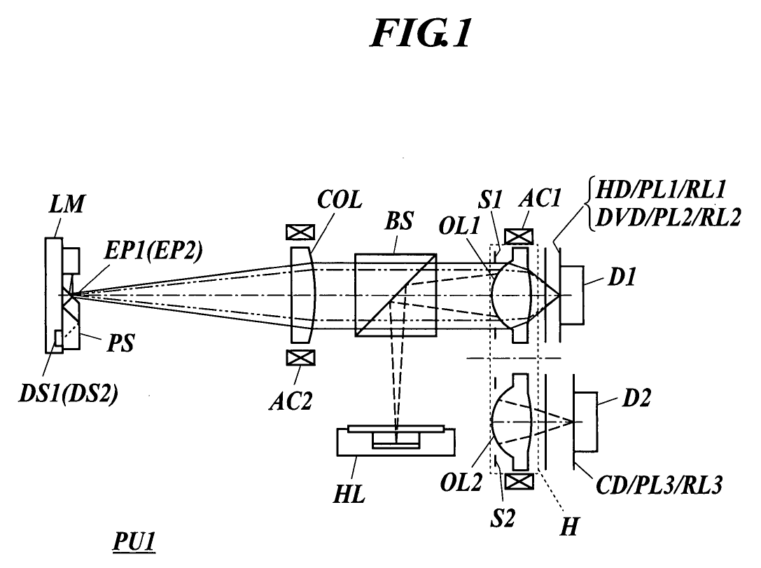

Hereinafter, a description is given of embodiments of the present invention using the drawings. First, an optical pickup device according to a first embodiment is described using FIG. 1. The optical pickup device PU1 according to this embodiment can be incorporated in an optical disk drive unit.

FIG. 1 is a view schematically showing a configuration of the optical pickup device PU1 capable of properly performing recording and/or reproduction of information in a compatible manner for an HD (first information recording medium), a DVD (second information recording medium), and a CD (third information recording medium). The optical specification of the HD is: wavelength λ1=407 nm; thickness t1 of a protective substrate PL1=0.6 mm; and numerical aperture NA1=0.65. The optical specification of the DVD is: wavelength λ2=655 nm; thickness t2 of a protective substrate PL2=0.6 mm; and numerical aperture NA2=0.65. The optical specification of the CD is: wavelength λ3=785 nm; thickness t3 of a protective substrate PL3=1.2 mm; and numerical aperture NA3=0.51. The combination of the wavelength, thickness of the protective layer, and numerical aperture are not limited to the above combinations. Each of the HD and DVD is configured to be rotatable integrally with a disk holder D1 (first recording medium drive unit) while being held on the rear side. The CD is configured to be rotatable integrally with a disk holder D2 (second recording medium drive unit) while being held on the rear side.

The optical pickup device PU1 includes a laser module LM and a hologram laser HL. The laser module LM includes a first light emitting point EP1 (first light source), a second light emitting point EP2 (second light source), a first light receiver DS1, a second light receiver DS2, and a prism PS. The first light emitting point EP1 emits a 407 nm blue-violet laser beam (first beam) when recording and/or reproduction of information is performed for the HD. The second light emitting point EP2 emits a 655 nm blue-violet laser beam (second beam) when recording and/or reproduction of information is performed for the DVD. The first light receiver DS1 receives a reflected beam from an information recording surface RL1 of the HD, and the second light receiver DS2 receives a reflected beam from an information recording surface RL2 of the DVD. The hologram laser HL is a light emitter/receiver integrated source unit including a third light source and a photodetector integrated. The third light source emits a 785 nm laser beam (third beam) when recording and/or reproduction of information is performed for the CD. A first objective optical element OL1 and a second objective optical element OL2 are held by a holder member (objective optical system drive unit) H which is driven by a not-shown actuator to move. An optical surface of the first objective optical element OL1 includes an aberration correcting structure to correct spherical aberration due to wavelength difference between the wavelengths λ1 and λ2 and chromatic aberration of the beam with the wavelength λ1. The second objective optical element OL2 includes such an aspheric surface that wavefront aberration is not more than 0.07λ3 rms when a focused spot is formed in the CD.

In the optical pickup device PU1, when recording and/or reproduction of information is performed for the HD, the holder member H is moved to a position shown in FIG. 1 to insert the first objective optical element OL1 to an optical path, and then the first emitting point EP1 is caused to emit light. A diverging beam emitted from the first light emitting point EP1, the beam route of which is indicated by real lines in FIG. 1, is converted to a collimated beam by a collimator COL, passed through a beam splitter BS, and restricted in beam diameter by a stop S1. The beam is then incident to the first objective optical element OL1 in an infinite collimated beam state to be a spot formed on the information recording surface RL1 through the protective substrate PL1 of the HD. The first objective optical element OL1 is driven to perform focusing and tracking together with the holder member H by a two-axis actuator AC1 disposed in the vicinity thereof.

The reflected beam modulated by an information pit on the information recording surface RL1 is transmitted again through the first objective optical element OL1, stop S1, beam splitter BS, and collimator COL and then made incident to the laser module LM. Thereafter, the incident beam is reflected twice in the prism PS and converged to the first light receiver DS1. Using an output signal from the first light receiver DS1, information recorded on the HD can be read.

In the optical pickup device PU1, when recording and/or reproduction of information is performed for the DVD, the holder member H is moved to the position shown in FIG. 1 to insert the first objective optical element OL1 to the optical path, and the collimator COL is moved by a single axis actuator AC2 in an optical axis direction. The second emitting point EP2 is then caused to emit light. A diverging beam emitted from the second light emitting point EP2, the beam route of which is indicated by dot-dash lines in FIG. 1, is converted to a slightly diverging beam by the collimator COL, passed through the beam splitter BS, and then restricted in beam diameter by the stop S. Thereafter, the beam is then incident to the first objective optical element OL1 in a finite diverging beam state and passed through the protective substrate PL2 of the DVD to be a spot formed on the information recording surface RL2. The first objective optical element OL1 is driven to perform focusing and tracking integrally with the holder member H by the two-axis actuator AC1 disposed in the vicinity thereof.

The reflected beam modulated by an information pit on the information recording surface RL2 is transmitted again through the first objective optical element OL1, stop S1, beam splitter BS, and collimator COL and then made incident to the laser module LM. Thereafter, the reflected beam is reflected twice in the prism PS and converged to the second light receiver DS2. Using an output signal from the second light receiver DS2, information recorded on the DVD can be read.

In the optical pickup device PU1, when recording and/or reproduction of information is performed for the CD, the holder member H is moved from the position shown in FIG. 1 upward in the drawing to insert the second objective optical element OL2 to an optical path, and then the hologram laser HL is caused to emit light. A diverging beam emitted from the hologram laser HL, the beam route of which is indicated by dotted lines in FIG. 1, is reflected by a beam splitter BS and then restricted in beam diameter by a stop S2. Thereafter, the beam is incident to the second objective optical element OL2 in a finite diverging beam and passed through the protective substrate PL3 of the CD to be a spot formed on the information recording surface RL3. The second objective optical element OL2 is driven to perform focusing and tracking integrally with the holder member H by the two-axis actuator AC1 disposed in the vicinity thereof.

The reflected beam modulated by an information pit on the information recording surface RL3 is transmitted again through the second objective optical element OL2 and stop S2 and reflected by the beam splitter BS. The reflected beam is then incident to the hologram laser HL and converged to the light receiving surface of the photodetector. Using an output signal from the photodetector, information recorded on the CD can be read.

In this embodiment, the first and second objective optical elements OL1 and OL2 constitute the first and second objective optical systems, respectively. The collimator COL constitutes a divergence angle changing element. The beam incident to the first objective optical element when the HD is used is the infinite collimated beam, and the beam incident to the first objective optical element when the DVD is used is the finite slightly diverging beam. However, the beams incident to the first objective optical element when the HD and DVD are used may be a finite slightly converging beam and an infinite collimated beam, respectively. Alternatively, both the beams may be infinite collimated beams. Furthermore, the beam incident to the second objective optical element when the CD is used is the finite diverging beam but may be an infinite collimated beam.

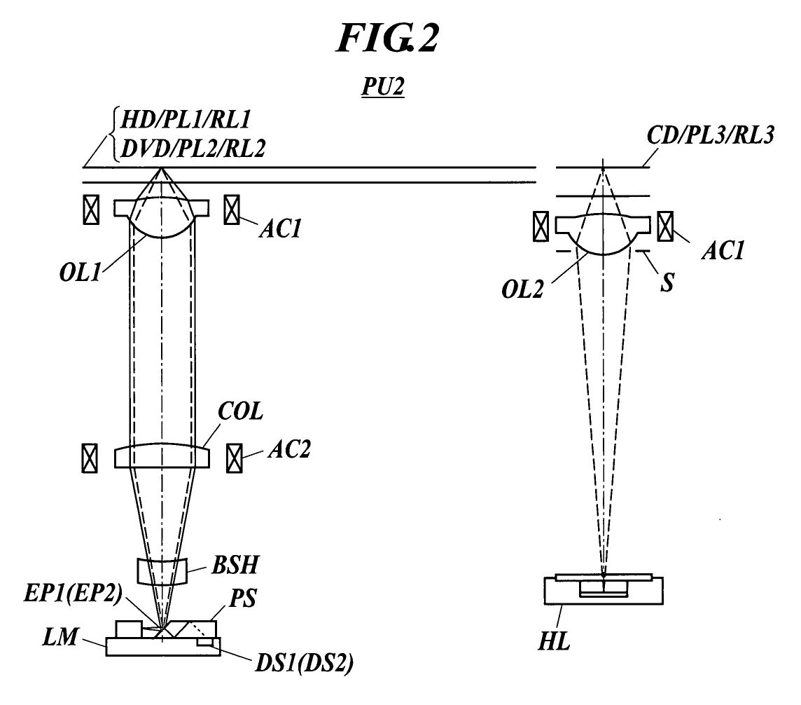

Next, a description is given of an optical pickup device according to a second embodiment using FIG. 2. FIG. 2 is a view schematically showing a configuration of an optical pickup device PU2 capable of properly performing recording and/or reproduction of information for each of a HD, a DVD, and a CD. The optical specification of the HD is: wavelength λ1=407 nm; thickness t1 of the protective substrate PL1=0.6 mm; and numerical aperture NA1=0.65. The optical specification of the DVD is: wavelength λ2=655 nm; thickness t2 of a protective substrate PL2=0.6 mm; and numerical aperture NA2=0.65. The optical specification of the CD is: wavelength λ3=785 nm; thickness t3 of the protective substrate PL3=1.2 mm; and numerical aperture NA3=0.51. The combination of the wavelength, thickness of the protective layer, and numerical aperture is not limited to the above combinations.

The optical pickup device PU2 includes a laser module LM and a hologram laser HL. The laser module LM includes a first light emitting point (first light source) EP1, a second light emitting point (second light source) EP2, a first light receiver DS1, a second light receiver DS2, and a prism PS. The first light emitting point EP1 emits a 407 nm blue-violet laser beam (first beam) when recording and/or reproduction of information is performed for the HD. The second light emitting point EP2 emits a 655 nm laser beam (second beam) when recording and/or reproduction of information is performed for the DVD. The first light receiver DS1 receives a reflected beam from an information recording surface RL1 of the HD, and the second light receiver DS2 receives a reflected beam from an information recording surface RL2 of the DVD. The hologram laser HL is a light emitter/receiver integrated source unit including a third light source and a photodetector integrated. The third light source emits a 785 nm laser beam (third beam) when recording and/or reproduction of information is performed for the CD. A first objective optical element OL1 and a second objective optical element OL2 are separately provided and driven by respective two-axis actuators AC1. An optical surface of the first objective optical element OL1 includes an aberration correcting structure for correcting spherical aberration due to the wavelength difference between the wavelengths λ1 and λ2 and chromatic aberration of a beam with the wavelength λ1. The second objective optical element OL2 includes such an aspheric surface that wavefront aberration is not more than 0.07λ3 rms when a focused spot is formed in the CD.

In the optical pickup device PU2, when recording and/or reproduction of information is performed for the HD, the first emitting point EP1 is caused to emit light. A diverging beam emitted from the first light emitting point EP1, the beam route of which is indicated by real lines in FIG. 2, is passed through a beam shaper BSH, converted to a collimated beam by a collimator COL, and then restricted in beam diameter by a not-shown stop. The beam is then made incident to the first objective optical element OL1 in an infinite collimated beam state to be a spot formed on the information recording surface RL1 through the protective substrate PL1 of the HD. The first objective optical element OL1 is driven to perform focusing and tracking by the two-axis actuator AC1 disposed in the vicinity thereof.

The reflected beam modulated by an information pit on the information recording surface RL1 is transmitted again through the first objective optical element OL1, stop, collimator COL, and beam shaper BSH and then incident to the laser module LM. Thereafter, the incident beam is reflected twice in the prism PS and converged to the first light receiver DS1. Using an output signal from the first light receiver DS1, information recorded on the HD can be read.

In the optical pickup device PU2, when recording and/or reproduction of information is performed for the DVD, the collimator COL is moved in the optical axis direction by a single axis actuator AC2 to a position different from that when the HD is used, and the second emitting point EP2 is caused to emit light. A diverging beam emitted from the second light emitting point EP2, the beam route of which is indicated by dotted lines in FIG. 2, is passed through the beam shaper BSH, converted to a slightly diverging beam by the collimator COL, and then restricted in beam diameter by a not-shown stop. Thereafter, the beam is incident to the first objective optical element OL1 in the finite diverging beam state to be a spot formed on the information recording surface RL2 through the protective substrate PL2 of the DVD. The first objective optical element OL1 is driven to perform focusing and tracking by the two-axis actuator AC1 disposed in the vicinity thereof.

The reflected beam modulated by an information pit on the information recording surface RL2 is transmitted again through the first objective optical element OL1, stop, collimator COL, and beam shaper BSH and then incident to the laser module LM. Thereafter, the incident beam is reflected twice in the prism PS and converged to the second light receiver DS2. Using an output signal from the first light receiver DS1, information recorded on the DVD can be read.

In the optical pickup device PU2, when recording and/or reproduction of information is performed for the CD, the hologram laser HL is caused to emit light. A diverging beam emitted from the hologram laser HL, the beam route of which is indicated by dot-dash lines in FIG. 2, is restricted in beam diameter by a stop S and then directly incident to the second objective optical element OL2 in a finite diverging beam state to be a spot formed on the information recording surface RL3 through the protective substrate PL3 of the CD. The second objective optical element OL2 is driven to perform focusing and tracking by the two-axis actuator AC1 disposed in the vicinity thereof.

The reflected beam modulated by an information pit on the information recording surface RL3 is transmitted again through the second objective optical element OL2 and stop S. The reflected beam is then directly incident to the hologram laser HL and converged to the light receiving surface of the photodetector. Using an output signal from the photodetector, information recorded on the CD can be read.

In this embodiment, the first and second objective optical elements OL1 and OL2 constitute first and second objective optical systems, respectively. The collimator COL constitutes a divergence angle converting element. The beam incident to the first objective optical element when the HD is used is the infinite collimated beam, and the beam incident to the first objective optical element when the DVD is used is the finite slightly diverging beam. However, the beams incident to the first objective optical element when the HD and DVD are used may be a finite slightly converging beam and an infinite collimated beam, respectively. Alternatively, both the beams may be infinite collimated beams. Furthermore, the beam incident to the second objective optical element when the CD is used is the finite diverging beam but may be an infinite collimated beam.

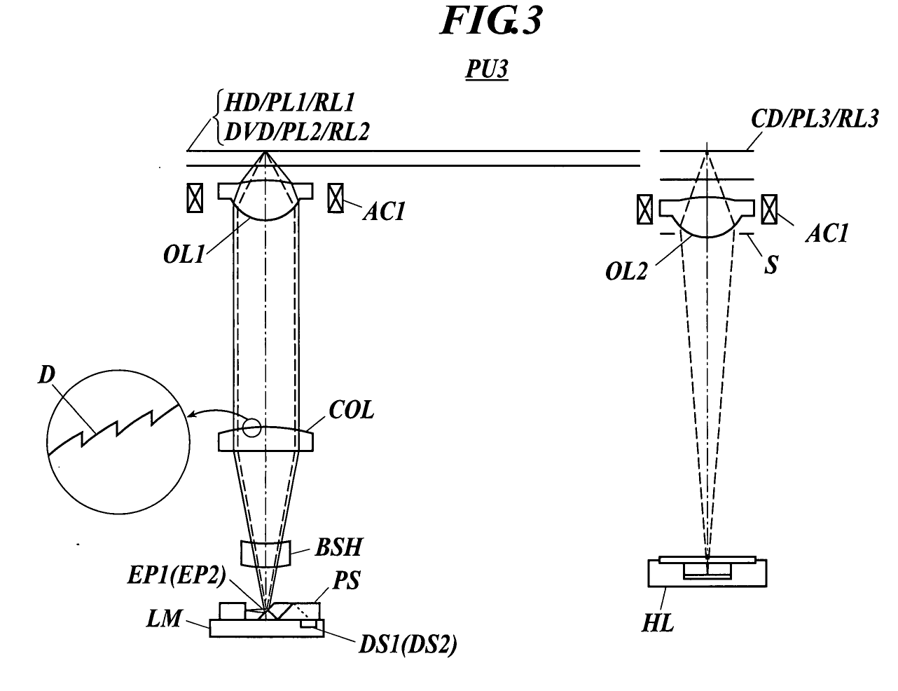

Next, a description is given of an optical pickup device according to a third embodiment using FIG. 3. FIG. 3 is a view schematically showing an optical pickup device PU3 capable of properly performing recording and/or reproduction of information for all of a HD, a DVD, and a CD. In the circle, an enlargement view of a part of a collimator COL is shown. The optical specification of the HD is: wavelength λ=407 nm; thickness t1 of a protective substrate PL1=0.6 mm; and numerical aperture NA1=0.65. The optical specification of the DVD is: wavelength λ2=655 nm; thickness t2 of a protective substrate PL2=0.6 mm; and numerical aperture NA2=0.65. The optical specification of the CD is: wavelength λ3=785 nm; thickness t3 of a protective substrate PL3=1.2 mm; and numerical aperture NA3=0.51. The combination of the wavelength, thickness of the protective layer, and numerical aperture is not limited to the above combinations.

The optical pickup device PU3 includes a laser module LM and a hologram laser HL. The laser module LM includes a first light emitting point (first light source) EP1, a second light emitting point (second light source) EP2, a first light receiver DS1, a second light receiver DS2, and a prism PS. The first light emitting point EP1 emits a 407 nm blue-violet laser beam (first beam) when recording and/or reproduction of information is performed for the HD. The second light emitting point EP2 emits a 655 nm laser beam (second beam) when recording and/or reproduction of information is performed for the DVD. The first light receiver DS1 receives a reflected beam from an information recording surface RL1 of the HD, and the second light receiver DS2 receives a reflected beam from an information recording surface RL2 of the DVD. The hologram laser HL is a light emitter/receiver integrated source unit including a third light source and a photodetector integrated. The third light source emits a 785 nm laser beam (third beam) when recording and/or reproduction of information is performed for the CD. A first objective optical element OL1 and a second objective optical element OL2 are separately provided and driven by respective two-axis actuators AC1. An optical surface of the first objective optical element OL1 includes an aberration correcting structure to correct spherical aberration due to the wavelength difference between the wavelengths λ1 and λ2 and chromatic aberration of a beam with the wavelength λ1. The second objective optical element OL2 includes such an aspheric surface that wavefront aberration is not more than 0.07λ3 rms when a focused spot is formed in the CD. Moreover, in the optical surface of the collimator COL on the optical disk's side, a diffraction structure D as a structure giving an optical path difference is formed. The diffraction structure D has such shape that when a beam with the wavelengthλ1 is passed through the diffraction structure D, a 0th order beam has the highest intensity, and when a beam with the wavelength λ2 is passed through the diffraction structure D, an n-th order beam (n: positive integral) has the highest intensity. In other words, the diffraction structure D has such a shape that the divergence angle varies depending on the wavelength.

In the optical pickup device PU3, when recording and/or reproduction of information is performed for the HD, the first emitting point EP1 is caused to emit light. A diverging beam emitted from the first light emitting point EP1, the beam route of which is indicated by real lines in FIG. 3, is passed through a beam shaper BSH, converted to a collimated beam by the collimator COL, and then restricted in beam diameter by a not-shown stop. The beam is then incident to the first objective optical element OL1 in the infinite collimated beam state to be a spot formed on the information recording surface RL1 through the protective substrate PL1 of the HD. The first objective optical element OL1 is driven to perform focusing and tracking by a two-axis actuator AC1 disposed in the vicinity thereof.

The reflected beam modulated by an information pit on the information recording surface RL1 is transmitted again through the first objective optical element OL1, stop, collimator COL, and beam shaper BSH and then incident to the laser module LM. Thereafter, the incident beam is reflected twice in the prism PS and converged to the first light receiver DS1. Using an output signal from the first light receiver DS1, information recorded on the HD can be read.

In the optical pickup device PU3, when recording and/or reproduction of information is performed for the DVD, the collimator COL is moved in the optical axis direction by a single axis actuator AC2, and the second emitting point EP2 is caused to emit light. A diverging beam emitted from the second light emitting point EP2, the beam route of which is indicated by dash dot dot lines in FIG. 3, is passed through the beam shaper BSH, converted to a slightly diverging beam by the collimator COL, and restricted in beam diameter by a not-shown stop. Thereafter, the beam is incident to the first objective optical element OL1 in a finite diverging beam state to be a spot formed on the information recording surface RL2 through the protective substrate PL2 of the DVD. The first objective optical element OL1 is driven to perform focusing and tracking by the two-axis actuator AC1 disposed in the vicinity thereof.

The reflected beam modulated by an information pit on the information recording surface RL2 is transmitted again through the first objective optical element OL1, stop, collimator COL, and beam shaper BSH and then incident to the laser module LM. Thereafter, the incident beam is reflected twice in the prism PS and converged to the second light receiver DS2. Using an output signal from the second light receiver DS2, information recorded on the DVD can be read.

In the optical pickup device PU3, when recording and/or reproduction of information is performed for the CD, the hologram laser HL is caused to emit light. A diverging beam emitted from the hologram laser HL, the beam route of which is indicated by dotted lines in FIG. 3, is restricted in beam diameter by the stop and then directly incident to the second objective optical element OL2 in a finite diverging beam state to be a spot formed on the information recording surface RL3 through the protective substrate PL3 of the CD. The second objective optical element OL2 is driven to perform focusing and tracking by the two-axis actuator AC1 disposed in the vicinity thereof.

The reflected beam modulated by an information pit on the information recording surface RL3 is transmitted again through the second objective optical element OL2 and stop S. The reflected beam is then directly incident to the hologram laser HL and converged to the light receiving surface of the photodetector. Using an output signal from the photodetector, information recorded on the CD can be read.

In this embodiment, the first and second objective optical elements OL1 and OL2 constitute first and second objective optical systems, respectively. The collimator COL constitutes a divergence angle converting element. The beam incident to the first objective optical element when the HD is used is the infinite collimated beam, and the beam incident to the first objective optical element when the DVD is used is the finite slightly diverging beam. However, the beam incident to the first objective optical element when the HD is used may be a finite slightly converging beam, and the beam incident to the first objective optical element when the DVD is used may be an infinite collimated beam. Alternatively, both the beams may be infinite collimated beams. Moreover, the beam incident to the second objective optical element when the CD is used is the finite diverging beam but may be an infinite collimated beam.

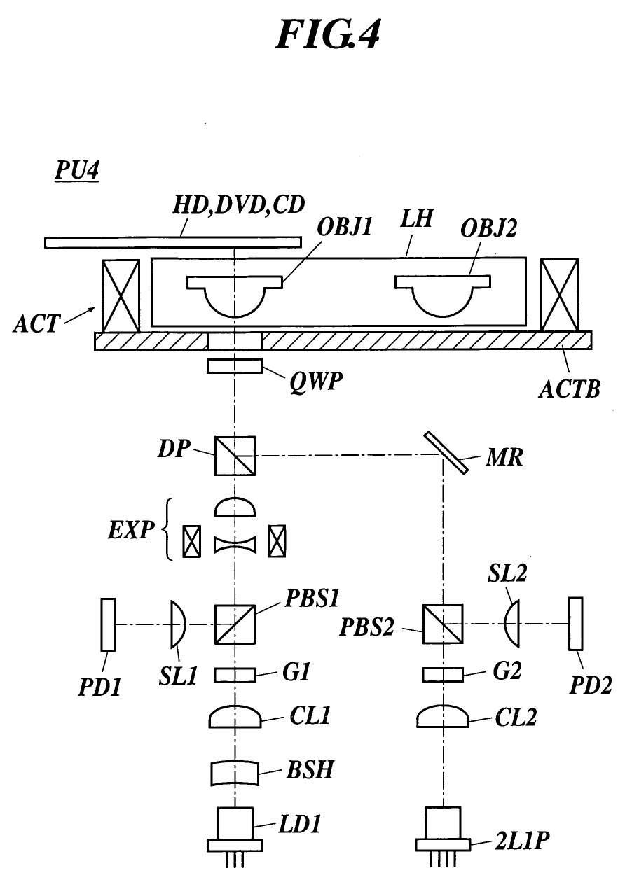

FIG. 4 is a schematic cross-sectional view of an optical pickup device PU4 according to a fourth embodiment which is capable of performing recording and/or reproduction of information for all of a HD, a DVD, and a CD. In this embodiment, a second semiconductor laser LD2 and a third semiconductor laser LD3 are accommodated in a same case to form a so-called 2 laser 1 package 2L1P. The optical specification of the HD is: wavelength λ1=407 nm; thickness t1 of the protective substrate PL1=0.6 mm; and numerical aperture NA1=0.65. The optical specification of the DVD is: wavelength λ2=655 nm; thickness t2 of a protective substrate PL2=0.6 mm; and numerical aperture NA2=0.65. The optical specification of the CD is: wavelength λ3=785 nm; thickness t3 of the protective substrate PL3=1.2 mm; and numerical aperture NA3=0.51. The combination of the wavelength, thickness of the protective layer, and numerical aperture is not limited to the above combinations.

As shown in FIG. 4, a lens holder LH (objective optical system drive unit) is supported by an actuator ACT so as to move at least in a two dimensional manner. The actuator ACT includes an actuator base ACTB attached to a frame (not shown) of the optical pickup unit PU4 such that the position thereof can be adjusted. The lens holder LH supporting objective lenses OBJ1 and OBJ2 can rotate at a middle point between both optical axes of the two objective lenses OBJ1 and OBJ2 can rotate around an axis extending substantially in parallel to the optical axes. When recording and/or reproduction of information is performed for the HD, the lens holder LH rotates to such a position that a beam having passed a quarter wave plate QWP is incident to the first objective lens OBJ1. When recording and/or reproduction of information is performed for the DVD or CD, the lens holder LH rotates to such a position that a beam having passed a quarter wave plate QWP is incident to the second objective lens OBJ2. The optical surface of the first objective lens OBJ1 includes an aberration correcting structure to correct chromatic aberration of the wavelength λ1 and such an aspheric surface that wavefront aberration is not more than 0.07λ1 rms when a focused spot is formed in the CD. The second objective lens OBJ2 includes an aberration correcting structure to correct spherical aberration due to the difference between the wavelengths λ2 and λ3 and correct spherical aberration due to the difference in thickness between protective substrates PL2 and PL3 of the DVD and CD.

When recording and/or reproduction of information is performed for the HD, the lens holder LH is rotated to a position shown in FIG. 4. In FIG. 4, a beam emitted from the first semiconductor laser (first light source) LD1 is passed through a beam shaper BSH to have a beam shape corrected and is then incident to a first collimating lens CL1 to be an infinite collimated beam. The beam emitted from the first collimating lens CL1 is passed through a first diffraction grating G1 and further passed through a first polarizing beam splitter PBS1 and an expander lens EXP.

The beam having passed through the expander lens EXP is passed through a dichroic prism DP, further passed through the quarter wave plate QWP, and condensed by the first objective lens OBJ1 to be focused on the information recording surface through the protective layer of the HD and form a focused spot.

The beam modulated and reflected by an information pit on the information recording surface is passed again through the first objective lens OBJ1, quarter wave plate QWP, dichroic prism DP, and expander lens EXP and reflected by the first polarizing beam splitter PBS1. The beam is then incident to a light receiving surface of the first photodetector PD1 through the first sensor lens SL1. Using an output signal from the first photodetector PD1, a reading signal of information recorded on the HD can be obtained.

Moreover, change in shape of the spot and change in light intensity due to change of position on the first photodetector PD1 are detected to perform focusing and tracking. Based on the focusing and tracking, the actuator ACT is driven to move the objective lens OBJ1 together with the lens holder LH so that the beam from the first semiconductor laser LD1 is focused on the information recording surface of the HD.

When recording and/or reproduction of information is performed for the DVD, the lens holder LH is rotated from the position shown in FIG. 4 to change the positions of the second and first objective lenses OBJ2 and OBJ1. A beam emitted from a second semiconductor laser (not shown) goes out of the 2 laser 1 package 2L1P and is incident to the second collimating lens CL2 to be an infinite collimated beam. The beam emitted from the second collimating lens CL1 is passed through a second diffraction grating G2 and further passed through a second polarizing beam splitter PBS2, reflected by a mirror MR, and then reflected by the dichroic prism DP. The reflected beam is then passed through the quarter wave plate QWP and condensed by the second objective lens OBJ2 to be focused on the information recording surface through the protective layer of the DVD and form a focused spot.

The beam modulated and reflected by an information pit on the information recording surface is passed again through the second objective lens OBJ2 and quarter wave plate QWP, reflected by the dichroic prism DP, and then reflected by the second polarizing beam splitter PBS2. The beam is then incident to a light receiving surface of the second photodetector PD2 through a second sensor lens SL2. Using an output signal from the second photodetector PD2, a reading signal of information recorded on the DVD can be obtained.

Moreover, change in shape of the spot and change in light intensity due to change of position on the second photodetector PD2 are detected to perform focusing and tracking. Based on the focusing and tracking, the actuator ACT is driven to move the second objective lens OBJ2 together with the lens holder LH so that the beam from the second semiconductor laser is focused on the information recording surface of the DVD.

When recording and/or reproduction of information is performed for the CD, the lens holder LH is rotated from the position shown in FIG. 4. A beam emitted from a third semiconductor laser (not shown) goes out of the 2 laser 1 package 2L1P and is then incident to the second collimating lens CL2 to be an infinite collimated beam. The beam emitted from the second collimating lens CL2 is passed through the second diffraction grating G2 and further passed through the second polarizing beam splitter PBS2.

The beam having passed through the polarizing beam splitter PBS2 is reflected by the mirror MR and then reflected by the dichroic prism DP. The beam is then passed through the quarter wave plate QWP and condensed by the second objective lens OBJ2 to be focused on the information recording surface thereof through the protective layer of the CD and form a focused spot.

The beam modulated and reflected by an information pit on the information recording surface is passed again through the second objective lens OBJ2 and quarter wave plate QWP, reflected by the dichroic prism DP, and then reflected by the mirror MR and the second polarizing beam splitter PBS2. The beam is then incident to the light receiving surface of the second photodetector PD2 through the second sensor lens SL2. Using the output signal from the third photodetector PD2, a reading signal of information recorded on the CD can be obtained.

Moreover, change in shape of the spot and change in light intensity due to change of position on the second photodetector PD2 are detected to perform focusing and tracking. Based on the focusing and tracking, the actuator ACT is driven to move the second objective lens OBJ2 together with the lens holder LH so that the beam from the third semiconductor laser LD3 is focused on the information recording surface of the CD.

In this embodiment, the first and second objective lens OBJ1 and OBJ2 constitute the first and second objective optical systems, respectively. The beam incident to the second objective optical system when the DVD is used is the infinite collimated beam but may be a finite slightly converging beam or a finite slightly diverging beam. The beam incident to the second objective optical element when the CD is used is the infinite collimated beam but may be a finite slightly converging beam or a finite slightly diverging beam.

### EXAMPLE 1

Next, a description is given of an example. Example 1 is an example of the first objective optical element OL1 suitable for the optical pickup device shown in FIGS. 1 to 3. The second objective optical element dedicated to the CD can be a publicly known optical element. Lens data of Example 1 is shown in Table 1. Hereinafter (including the lens data in the table), an exponential in decimal (for example, 2.5×10−3) is represented using E (for example, 2.5E-3).

TABLE 1
Lens data of Example 1

| | | |
|---|---|---|
| Objective Lens | f₁ = 2.30 mm | f₂ = 2.36 mm |
| Focal Length | | |
| Image Side | NA1: 0.65 | NA2: 0.65 |
| Numerical | | |
| Aperture | | |
| Second Surface | n1: 3 | n2: 2 |
| Diffraction | | |
| Order | | |
| Magnification | m1: 0 | m2: 0 |

| i-th | | | | | |
|---|---|---|---|---|---|
| sur- | | di | ni | di | ni |
| face | ri | (407 nm) | (407 nm) | (655 nm) | (655 nm) |
| 0 | | ∞ | | ∞ | |
| 1 | ∞ | 0.01 | | 0.01 | |
| (Stop | | (φ2.99 mm) | | (φ 3.07 mm) | |
| Size) | | | | | |
| 2 | 1.55196 | 1.40000 | 1.559806 | 1.40000 | 1.540725 |
| 3 | −8.23971 | 1.12 | 1.0 | 1.16 | 1.0 |
| 4 | ∞ | 0.6 | 1.61869 | 0.6 | 1.57752 |
| 5 | ∞ | | | | |

*di represents a distance between the i-th and (i + 1)-th surfaces.

Aspheric data
Second surface
Aspheric coefficient

| | |
|---|---|
| κ | −2.5377E−01 |
| A4 | −9.5198E−03 |
| A6 | −5.2537E−03 |
| A8 | 4.0508E−03 |
| A10 | −2.8485E−03 |
| A12 | 8.1205E−04 |
| A14 | −1.8971E−04 |

Function of optical path difference

| | |
|---|---|
| C2 | −1.2267E+01 |
| C4 | −1.0085E+00 |
| C6 | −1.4478E+00 |
| C8 | 6.6731E−01 |
| C10 | −1.4060−01 |

Third surface
Aspheric coefficient

| | |
|---|---|
| κ | −5.0000E+00 |
| A4 | 1.5346E−02 |
| A6 | 3.0181E−02 |
| A8 | −4.2087E−02 |
| A10 | 2.3341E−02 |
| A12 | −6.6328E−03 |
| A14 | 8.0143E−04 |

The optical surface of the first objective optical element is formed into an aspheric surface symmetrical around the optical axis and is defined by Formula 1 with the coefficients shown in Table 1 assigned.

$$X = \frac{( {H}^{2} / r )}{1 + \sqrt{1 - ( 1 + κ ) {( H / r )}^{2}}} + {\sum }_{i = 1}^{9} {A}_{2 i} {H}^{2 i} \qquad Formula 1$$

Herein, H is height from the optical axis, K is a conical constant, A₂ᵢ is the aspheric coefficient, and r is a radius of curvature (mm).

Moreover, the optical path length given by the diffraction structure to a beam of each wavelength is defined by the function of optical path difference with the coefficients of Table 1 assigned.

$$Φ ( H ) = ( {\sum }_{i = 1}^{5} {C}_{i} ⨯ {H}^{i} ) ⨯ λ \qquad Formula 2$$

Herein, H is the height from the optical axis, Cᵢ is a coefficient of the function of optical path difference, and λ is wavelength of the incident beam.

The present invention is not limited to the aforementioned embodiments. For example, the first objective optical element is shared by the HD and DVD, and the second objective optical element is exclusive to the CD. However, the first objective element may be exclusive to the HD, and the second objective optical element may be shared by the DVD and CD. In such a case, it is preferable that the light source for the HD is a hologram laser and the light source for the DVD and CD is a laser module including the second and third light source integrated. Moreover, the high-density disk is not limited to the HD and may be a BD.

### EFFECTS OF THE INVENTION

According to the present invention, it is possible to provide an optical pickup device capable of properly performing recording and/or reproduction of information for three kinds of disks with different recording densities, including high density optical disks using a blue-violet laser source, DVDs, and CDs, while suppressing the occurrence of coma at tracking and keeping a compact structure.

What is claimed is:

1. An optical pickup device, comprising:
a first light source for emitting a first beam with a wavelength λ1 to perform recording and/or reproduction of information for an information recording surface of a first optical information recording medium having a protective substrate with a thickness t1;
a second light source for emitting a second beam with a wavelength λ2 (λ2>λ1) to perform recording and/or reproduction of information for an information recording surface of a second optical information recording medium having a protective substrate with a thickness t2 (t2>t1);
a third light source for emitting a third beam with a wavelength λ3 (λ3>λ2) to perform recording and/or reproduction of information for an information recording surface of a third optical information recording medium having a protective substrate with a thickness t3 (t3>t2);
a first objective optical system for guiding at least the first beam to the information recording surface of the first optical information recording medium;
a second objective optical system provided separately from the first objective optical system, for guiding at least the third beam to the information recording surface of the third optical information recording medium; and
at least one light receiving element for detecting light reflected on the information recording surfaces of the first to third optical information recording media,
wherein the second beam is guided through one of the first and second objective optical systems to the information recording surface of the second optical information recording medium,
at least one of the first and second beams is incident to the first objective optical system or the second objective optical system in an infinite collimated beam state and divergence degree of the first beam is not larger than divergence degree of the second beam.

2. The optical pickup device of claim 1, wherein the second beam is guided to the information recording surface of the second optical information recording medium through the first objective optical system.

3. The optical pickup device of claim 2, wherein each of the first and second beams is incident to the first objective optical system in the infinite collimated beam state.

4. The optical pickup device of claim 2, wherein the first beam is incident to the first objective optical system in the infinite collimated beam state, and the second beam is incident to the first objective optical system in a finite diverging beam state.

5. The optical pickup device of claim 2, wherein the first beam is incident to the first objective optical system in a finite converging beam state, and the second beam is incident to the first objective optical system in the infinite collimated beam state.

6. The optical pickup device of claim 2, wherein the first objective optical system comprises an aberration correcting structure which corrects spherical aberration due to a difference in wavelength between the first and second beams and/or chromatic aberration of the first beam.

7. The optical pickup device of claim 6, wherein the second objective optical system comprises an aspheric surface which has a wavefront aberration of not less than 0.07λ3 rms when a focused spot is formed on the information recording surface of the third optical information recording medium.

8. The optical pickup device of claim 2, further comprising:
an objective optical system drive unit for holding the first and second objective optical systems and for switching between the first and second objective optical systems depending on one of the optical information recording media subjected to reproduction and/or recording of information.

9. The optical pickup device of claim 2, further comprising:
a first recording medium drive unit for holding and rotatably driving the first and second optical information recording media when recording and/or reproduction of information is performed for the first and second information recording media; and
a second recording medium drive unit for holding and rotatably driving the third optical information recording medium when recording and/or reproduction of information is performed for the third optical information recording medium.

10. The optical pickup device of claim 2, further comprising:
a first optical system comprising the first and second light sources, the first objective optical system, and a first photodetector; and
a second optical system comprising the third light source, the second objective optical system, and a second photodetector, the first and second optical systems being independently provided,
wherein the first optical system is used when reproduction and/or recording is performed for the first and second optical recording media, and the second optical system is used when reproduction and/or recording is performed for the third optical information recording medium.

11. The optical pickup device of claim 2, further comprising:
a beam splitter for transmitting at least one of the beams and bending an optical path of at least another one of the beams when the first to third beams pass through the beam splitter in an optical path common to the first to third beams,
wherein the first and second beams having passed through the beam splitter are incident to the first objective optical system and the third beam having passed through the beam splitter is incident to the second objective optical system.

12. The optical pickup device of claim 2, wherein the first and second light sources are assembled into a single unit.

13. The optical pickup device of claim 2, further comprising:
a divergence angle converting element for changing divergence degree of the beams incident to the first objective optical system.

14. The optical pickup device of claim 13, wherein the divergence angle converting element comprises a wavelength selective optical path giving structure and varies the divergence degree between the first and second beams.

15. The optical pickup device of claim 13, wherein the divergence angle converting element is movable in an optical axis direction and is disposed at different positions between a case in which the first beam is transmitted and a case in which the second beam is transmitted.

16. The optical pickup device of claim 13, wherein the light receiving element is shared when reproduction and/or recording of information is performed for the information recording surfaces of the first and second optical information recording media.

17. The optical pickup device of claim 2, wherein the third beam is incident to the second objective optical system in a finite diverging beam state.

18. The optical pickup device of claim 2, wherein the third beam is incident to the second objective optical system in an infinite collimated beam state.

19. The optical pickup device of claim 3, wherein the third beam is incident to the second objective optical system in an infinite collimated beam state.

20. The optical pickup device of claim 19, wherein the light receiving element is shared when reproduction and/or recording of information is performed for the information recording surfaces of the first, second, and third optical information recording media.

21. The optical pickup device of claim 1, wherein the second beam is guided to the information recording surface of the second optical information recording medium through the second objective optical system.

22. The optical pickup device of claim 21, wherein the first beam is incident to the first objective optical system in the infinite collimated beam state and the second beam is incident to the second objective optical system in the infinite collimated beam state.

23. The optical pickup device of claim 21, wherein first beam is incident to the first objective optical system in the infinite collimated beam state, and the second beam is incident to the second objective optical system in a finite diverging beam state.

24. The optical pickup device of claim 21, wherein the first beam is incident to the first objective optical system in a finite converging beam state and the second beam is incident to the second objective optical system in the infinite collimated beam state.

25. The optical pickup device of claim 21, wherein the first objective optical system comprises a first aberration correcting structure for correcting chromatic aberration of the first beam.

26. The optical pickup device of claim 21, wherein the second objective optical system comprises a second aberration correcting structure which corrects spherical aberration due to a wavelength difference between the second and third beams and spherical aberration due to a thickness difference between the protective substrates of the second and third optical information recording medium.

27. The optical pickup device of claim 21, wherein the first objective optical system comprises an aspheric surface which has wavefront aberration not less than 0.07λ1 rms when a focused spot is formed on the information recording surface of the first optical information recording medium.

28. The optical pickup device of claim 21, further comprising:
an objective optical system drive unit for holding the first and second objective optical systems and switching between the first and second objective optical systems depending on one of the optical information recording media subjected to reproduction and/or recording of information.

29. The optical pickup device of claim 21, further comprising:
a first recording medium drive unit for holding and rotatably driving the first optical information recording medium when recording and/or reproduction of information is performed for the first optical information recording medium; and
a second recording medium drive unit for holding and rotatably driving the second and third optical information recording media when recording and/or reproduction of information is performed for the second and third optical information recording media.

30. The optical pickup device of claim 21, further comprising:
a first optical system comprises the first light source, the first objective optical system, and a first photodetector; and
a second optical system comprises the second and third light sources, the second objective optical system, and a second photodetector, the first and second optical system being independently provided,
wherein the first optical system is used when reproduction and/or recording is performed for the first optical information recording medium, and the second optical system is used when reproduction and/or recording is performed for the second and third optical information recording media.

31. The optical pickup device of claim 21, further comprising:
a beam splitter for transmitting at least one of the beams and bending an optical path of at least another one of the beams when the first to third beams pass through the beam splitter in an optical path common to the first to third beams,
wherein the first beam having passed through the beam splitter is incident to the first objective optical system and the second and third beams having passed through the beam splitter are incident to the second objective optical system.

32. The optical pickup device of claim 21, wherein the second and third light sources are assembled into a single unit.

33. The optical pickup device of claim 21, wherein the third beam is incident to the second objective optical system in a finite diverging beam state.

34. The optical pickup device of claim 21, wherein the third beam is incident to the second objective optical system in the infinite collimated beam state.

35. The optical pickup device of claim 22, wherein the third beam is incident to the second objective optical system in the infinite collimated beam state.

36. The optical pickup device of claim 35, wherein the light receiving element is shared when reproduction and/or recording of information is performed for the information recording surfaces of the first, second, and third optical information recording media.
